(19) United States
(12) Patent Application Publication
(10) Pub. No.: US 2023/0253859 A1
(43) Pub. Date: Aug. 10, 2023

(54) RETRACTABLE AND DETACHABLE WHEEL-BASED TIRE GENERATOR TYPE RANGE EXTENDER AND RECHARGER FOR ELECTRIC VEHICLES

(71) Applicant: Michael Curtis Grayson, Bolivar, TN (US)

(72) Inventor: Michael Curtis Grayson, Bolivar, TN (US)

(21) Appl. No.: 17/968,501

(22) Filed: Oct. 18, 2022

Related U.S. Application Data
(63) Continuation-in-part of application No. 17/590,779, filed on Feb. 1, 2022.
Application No. 17/590,779 is a continuation of application No. 16/801,505, filed on Feb. 26, 2020, now abandoned.
(60) Provisional application No. 63/256,694, filed on Oct. 18, 2021.

(51) Int. Cl. H02K 7/18; B60L 53/50; H02J 7/00; B60L 53/60; H02K 11/00; B60L 50/90

(52) U.S. Cl. CPC H02K 7/1846; B60L 50/90; B60L 53/50; B60L 53/60; H02J 7/007; H02K 11/0094

(57) ABSTRACT

A hubless wheel-based generator of a range extender and recharger for an electric vehicle. The wheel-based generator of a range extender and recharger includes an armature winding, rim, center ring, bearing inner ring, bearing outer ring, frame, cap sprocket, tire, permanent magnets, charge controller and battery bank. These components form a high efficiency, brushless generator design that utilizes the wheel well and or wheel cover, together with the mechanical energy of the tire itself to create a frictionless brushless generator that will deliver power to the engine directly or can be diverted to the battery bank for recharging. The generator can be built into the wheel well of the electric vehicle, placed in a side car-based system mounted alongside the vehicle or towed behind the vehicle in a portable charging system configured as a generator that uses the same principle of converting the mechanical energy of the tire into electricity.

### CROSS REFERENCE TO RELATED APPLICATION

This application claims the benefit of U.S. Provisional Pat. Application serial no. 63/256,694, filed Oct. 18, 2021, the entire contents and disclosure of which are hereby incorporated herein by reference. This application is a continuation-in-part of U. S. Pat. Application Serial No. 17/590,779 filed Feb. 1, 2022, which is a continuation of U. S. Pat. Application Serial No. 16/801,505 filed Feb. 26, 2020. The entire contents and disclosures of U. S. Pat. Application Serial No. 17/590,779 and U. S. Pat. Application Serial No. 16/801,505 are incorporated by reference as if fully set forth herein.

### FIELD OF INVENTION

The present invention relates to a portable retractable attachable/detachable wheel-based standalone generator of a range extender and recharger for electric vehicles, equipment, heavy machinery (“vehicles”) dramatically increasing the vehicles driving range and greatly reducing or eliminating the need for recharging.

### BACKGROUND

Although pure electric vehicles have the advantage of energy-savings, environmental protection, and zero discharge, the continual mileage range is currently very limited. In order to achieve mass application and acceptance of the electric vehicle, the range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles the solution is not as simple. The average range of an electric vehicle is currently 150 miles. Adding more battery as the solution for perceived range needs only adds more cost to the profitability-challenged electrified vehicle. Vehicle Costs Already Too High for Mainstream Customers and given the inherent cost disadvantages faced by EV’s vs. conventional vehicles and less financial policy support in the future, even the current $50 per additional mile of cost to the vehicle is quite impractical, given the number/frequency of trips that truly require most of the battery range. Larger batteries will also incur larger warranty expenses for the OEM as well as greater freight & recycling costs.

More Mass on the Vehicle. Batteries are very heavy. Compensating with Lightweight Materials is Expensive. In order to meet very stringent fuel economy & CO2 targets globally (primarily China, Europe, US & CA), all vehicles will have to be lighter and more mass efficient. Automotive OEM’s will pay more in premium materials for weight savings. Adding 4 lbs. of battery mass is roughly equal to 1 mile of EV range. Longer Charging Times to Top-off. Charging Infrastructure for Long Distance Trips under currently under development however no solution is close at hand.

Key Customers today are very accustomed to short re-fueling times at gas stations. Charging an EV is a much different experience and has been a challenge since the days of Edison’s efforts to supply the first batteries for electric cars. The larger the batteries become, the more and faster charging solutions that are required and continuous high-power charging can increase battery degradation.

Less Packaging Space for other Components. More stuff on vehicles with high tech features and autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption.

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass As the battery grows and the mass of the vehicle increases, other components from brakes, suspension, thermal management, etc. must be designed and reinforced to handle these challenges; the result is even more mass and cost added to the vehicle.

Without solutions to all these problems the electric vehicle just cannot advance.

### SUMMARY

Aspects of the present invention relate to addressing each of these problems in a practical, reliable and cost-effective way. There is provided a wheel basedpermanent magnet generator having the advantage of high efficiency, high power density, and has more wide application prospect.

In an aspect, the current invention is directed to systems and methods for the conversion of the wheel assembly into a permanent magnet generator.

In a further aspect, there is provided a portable retractable attachable/detachable wheel-based standalone generator of a range extender and recharger for electric vehicles comprises an assembly having a flat pancake armature winding device component, pancake shaped permanent magnet component, a charge cable component, a flush mount EV charging plug component, a custom cover, a universal smart charge controller component (including drive charge, over charge switch, on off, inverter, rectifier), an attachment harness, and shock absorber and stabilizer components that can be installed at various locations on a vehicle.

In this aspect, the portable retractable attachable/detachable wheel-based standalone generator of a range extender is a power recharger that can be added to existing electric vehicles whose range is deemed to be insufficient by the users of said vehicle. This wheel-based range extender and recharger for electric vehicles dramatically increases the vehicle’s driving range and greatly reduces or eliminates the need for recharging by capturing the rotational energy of the attached wheel and using it to power a generator built into the attached wheel. The power is diverted to a charge controller which allows the vehicle to charge while driving and converts the charge into an acceptable format to be accepted by the vehicle.

In a further aspect, the portable retractable attachable/detachable wheel-based standalone generator of a range extender is configurable to deliver power to the engine directly or can be diverted to the battery bank for recharging. This device is a Level 2 charger and can readily charge an EV in 4-10 hours at targeted speed then detached and stored in the storage compartment or trunk of the vehicle.

### BRIEF DESCRIPTION OF THE DRAWINGS

FIG. 1 is a diagram of an attached wheel-type electric vehicle generator range extender and recharger according to one embodiment wherein a wheel equipped with a shock absorber-based system to allow the wheel to come in contact with a surface such that the wheel will rotate at the speed of the vehicle and the wheel is configured to generate electricity for charging a battery;

FIG. 2 is a close up view of a charging plug and hose assembly for a portable retractable attachable/detachable wheel-type electric vehicle generator range extender and recharger according to an embodiment;

FIG. 3 shows an embodiment of a vehicle that includes an attached extra wheel including standalone power generator according to an embodiment;

FIG. 4 depicts a configuration of a charge port configured as a receptacle structure that protrudes from the car or vehicle hood and which can be covered with an aerodynamic device covering while driving to protect the assembly from environmental elements;

FIG. 5 depicts an embodiment of a smart charge controller for use in the on-board charging system shown in FIG. 3;

FIG. 6 depicts the wheel-based generator device located in the tire (wheel) and including the diversion of power up along or through the absorber housing shaft according to an embodiment;

FIG. 7 depicts an exploded view of wheel-type electric vehicle generator range extender and recharger that includes a pancake-shaped generator used as a level 2 charger

FIG. 8 shows an attachable wheel including multiple permanent steel magnetic spokes arranged at intervals around a center wheel hub in an example embodiment; and

FIG. 9 depicts a side car-based system including a wheel mounted alongside the vehicle in an embodiment.

### DETAILED DESCRIPTION

In one aspect, the portable retractable attachable/detachable wheel-based standalone generator of a range extender is a power recharger that can be added to existing electric vehicles whose range is deemed to be insufficient by the users of said vehicle. This wheel-based range extender and recharger for electric vehicles dramatically increases the vehicle’s driving range and greatly reduces or eliminates the need for recharging by capturing the rotational energy of the attached wheel and using it to power a generator built into the attached wheel. The power (generated electricity) is diverted to a charge controller which allows the vehicle to charge while driving and converts the charge into an acceptable format to be accepted by the vehicle.

In a further aspect, the portable retractable attachable/detachable wheel-based standalone generator of a range extender is configurable to deliver power to the engine directly or can be diverted to the battery bank for recharging. In an embodiment, this device is a Level 2 charger and can readily charge an EV in 4-10 hours at targeted speed then detached and stored in the storage compartment or trunk of the vehicle.

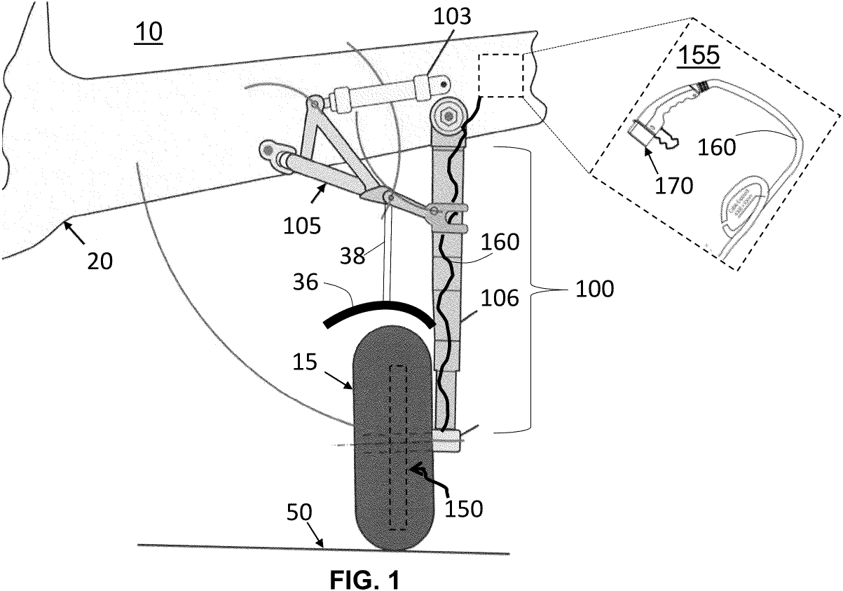

FIG. 1 is a diagram of an attached wheel-type electric vehicle generator range extender and recharger 10 according to one embodiment, wherein an extra or additional wheel 15 is attached to the electric vehicle in various locations such as under the vehicle chassis or frame 20 or mounted at the side of the vehicle (side car generator) or towed behind the vehicle (rear trailer generator). Each wheel is equipped with a mounting assembly, e.g., a detachable control arm 103, a retractable/detachable support harness assembly 105 and includes a shock absorber system 100 to allow the wheel to come in contact with the surface of a road on which the vehicle is traveling. Shock absorber system 100 includes typical vehicle shock-absorber components such as a housing shaft 106 containing the absorber and/or spring 102 located above the wheel axle.

The wheel 15 includes a wheel power generator system 150 such that, once in contact with the surface the attached or extra wheel 15 will rotate at the speed of the vehicle to produce electricity. In an embodiment, a fixed wheel cover or like surrounding stationary wheel well structure 36 in proximity to the wheel and connected to the support assembly 105 via a connection assembly 38. For electric vehicles the front wheel cover is movable, and for use as a back wheel, is a stationary back wheel cover. The wheel cover can include an armature component (not shown) functioning as a stator element of the wheel power generator device 150 while the rotating wheel is configured as a rotor to produce electricity. That is, in an embodiment, a portion of the wheel is configurable as a rotor that produces a rotating magnetic flux or rotating magnetic field associated with the rotor inducing electricity in an armature coil attachedto the wheel well or wheel cover 36.

That is, in this device, the rotor provides a rotating magnetic field that drives the rotating armature; the rotor is connect to the wheel and takes advantage of the rotational energy of the tire; in this generator range extender charger device, the stator coil, located in the wheel housing converts the rotating magnetic field of the rotor, located in the housing, into an electric current which is used to recharge the battery bank or power the vehicle. This device is retractable and detachable. This device provides emergency power and can serve as a long-distance solution and alternative to the hassle of locating charging stations and diverting time to recharge away from the trip itself.

The device is mounted on a shock absorber system that allows it to be in maximum contact with the road with better drivability. The stator of these devices may be either a permanent magnet or an electromagnet. Where the stator is an electromagnet, the coil which energizes it is known as the field coil or field winding. The coil can be either iron core or aluminum. To reduce loading losses in the device copper can be used as the conducting material in windings. Aluminum, because of its lower electrical conductivity, may be an alternate material. The device is able to produce power across multiple high-current power generation coils connected in parallel. Placing the field coils on the stator allows for an inexpensive mechanism to transfer high-voltage, low current power to the field coil.

In one embodiment, shown in FIG. 1, connected to the wheel power generator system 150 includes a power cabling and attached charge plug assembly 155 including a power cable or hose 160 that electrically connects to wheel generator system and can be snaked along the shock-absorber housing shaft 106. In embodiments, the power cabling assembly 155 can be contained in a protective coating or hose that can be flush mounted to the shaft 106. As shown in the close-up view in FIG. 1, the power cabling 160 conveys the charge produced from the wheel generator system 150 to a charge plug 170 that can mate with or otherwise engage a charge port provided on the vehicle used for charging the battery. In an embodiment, the charge plug can be clipped or connected to the charge port using magnetic mounting brackets while conveying wheel-generated electricity into a smart charge control system (not shown).

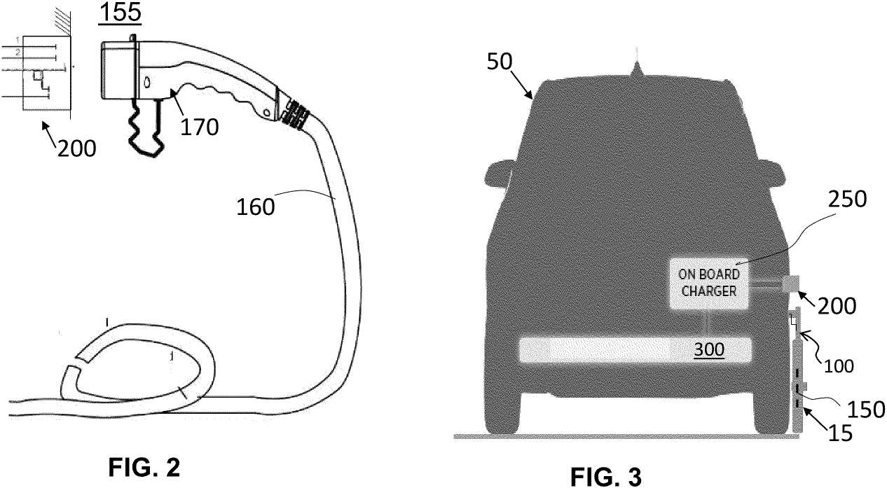

FIG. 2 shows an embodiment depicting the power cabling and attached charge plug assembly 155 having a power cable or hose 160 and charge plug or collapsible flush mount nozzle 170 that is extendable to reach and electrically connect to, i.e., plug into, a standard vehicle charge port 200 or a custom flush mount charge port and convey power to the vehicle battery.

FIG. 3 shows an embodiment of a vehicle 50 that includes an attached wheel 15 including standalone power generator 150. The standard vehicle charge port 200 (e.g., J1772 standard) or a direct-current (DC) or alternating current (AC) custom flush-mount charge port that receives the charge plug assembly from the extra wheel power generator 150. The port 200 interfaces with an on-board charger system 250 to store and/or divert and convey power to the vehicle battery 300.

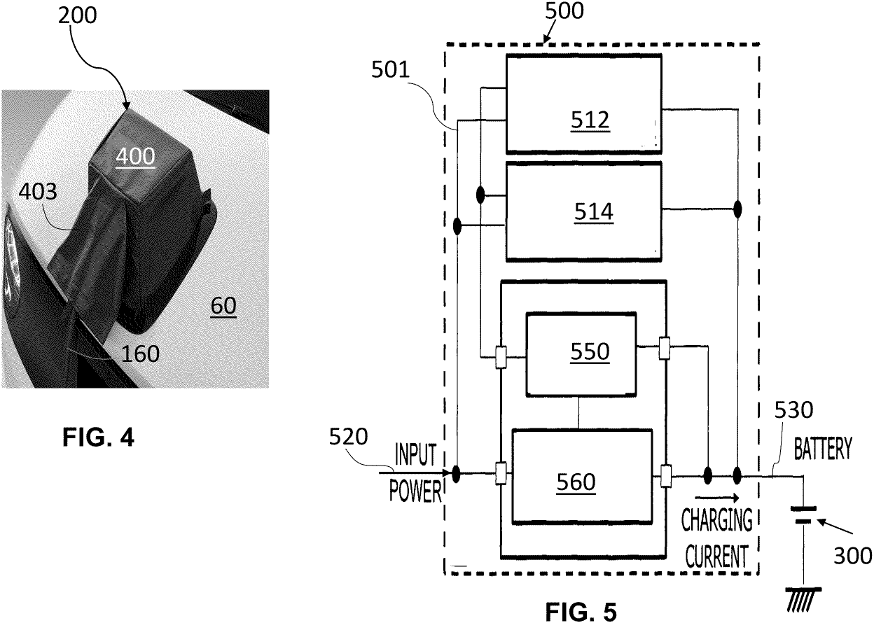

In an embodiment, as shown in FIG. 4, the charge port 200 may be configured as a receptacle structure (flush mounted outlet) that protrudes from the car or vehicle hood 60 and which can be covered with an aerodynamic device covering 400 while driving to protect the assembly from environmental elements (e.g., wind, precipitation, etc.). In this embodiment, the charge hose 160 can be connected to the vehicle using magnetic mounting brackets (not shown). The aerodynamic device covering 400 can include a portion 403 that covers the charge nozzle or plug portion for further protection. In embodiments, the charge port 200 is installed as a recessed outlet to improve aerodynamics.

Referring to FIG. 5 there is depicted a smart charge controller 500 for use in the on-board charging system 250 of FIG. 3. This device converts the charge coming from the wheel-based generator 150 into a usable current which the vehicle can accept. Smart charge controller 500 allows charging while the vehicle is in a driving mode and has a computer controlled on/off switch that ensures that the device will not overcharge and is activated when battery charge is detected as being low. Smart charge controller 500 includes a first charging path 501 receiving input power 520 from the charge nozzle of the power cabling assembly 155. Via charge path 501, inverter circuit 512 and rectifier circuit 514 components process the received power for output as charging current 530 used to charge the battery 300. Control circuit 550 is operable to control the use of inverter and rectifier circuits 512, 514 when providing the charge current to the battery. In embodiments, the control circuitry 550 can initiate bypass circuit 560 in order to provide the received wheel-generated input power 520 as charging current 530 for direct input to the battery 300 bypassing the inverter and rectifier circuits.

In a further embodiment, the electricity produced is then diverted to the charge controller 550. The charge controller now powers the engine directly or recharges the battery based on the needs of the pre- programmed needs vehicle. A charge controller, charge regulator or battery regulator limits the rate at which electric current is added to or drawn from electric batteries. It prevents overcharging and may protect against overvoltage, which can reduce battery performance or lifespan and may pose a safety risk. It may also prevent completely draining (“deep discharging”) a battery, or perform controlled discharges, depending on the battery technology, to protect battery life. The terms “charge controller” or “charge regulator” may refer to either a stand-alone device, or to control circuitry integrated within a battery pack, battery-powered device, or battery charger. Thecharge controllers may also be called a power regulator. The charge controller has additional features, such as a low voltage disconnect (LVD), a separate circuit which powers down the load when the batteries become overly discharged (some battery chemistries are such that over- discharge can ruin the battery). A series charge controller or series regulator disables further current flow into batteries when they are full. A shunt charge controller or shunt regulator divertsexcess electricity to an auxiliary or “shunt” load, such as an electric water heater, when batteries are full. Simple charge controllers stop charging a battery when they exceed a set high voltage level and re-enable charging when battery voltage drops back below that level. Pulse width modulation (PWM) and maximum power point tracker (MPPT) technologies are more electronically sophisticated, adjusting charging rates depending on the battery’s level, to allow charging closer to its maximum capacity. A charge controller with MPPT capability frees the system designer from closely matching available PV voltage to battery voltage. Considerable efficiency gains can be achieved, particularly when the PV array is located at some distance fromthe battery. By way of example, a 150 volt PV array connected to an MPPT charge controller canbe used to charge a 24 or 48 volt battery. Higher array voltage means lower array current, so the savings in wiring costs can more than pay for the controller. Charge controllers may also monitorbattery temperature to prevent overheating. Some charge controller systems also display data, transmit data to remote displays, and data logging to track electric flow over time. Circuitry that functions as a charge regulator controller may consist of several electrical components, or may beencapsulated in a single microchip, an integrated circuit (IC) usually called a charge controller ICor charge control IC. The smart charge controller also allows for charging while driving.

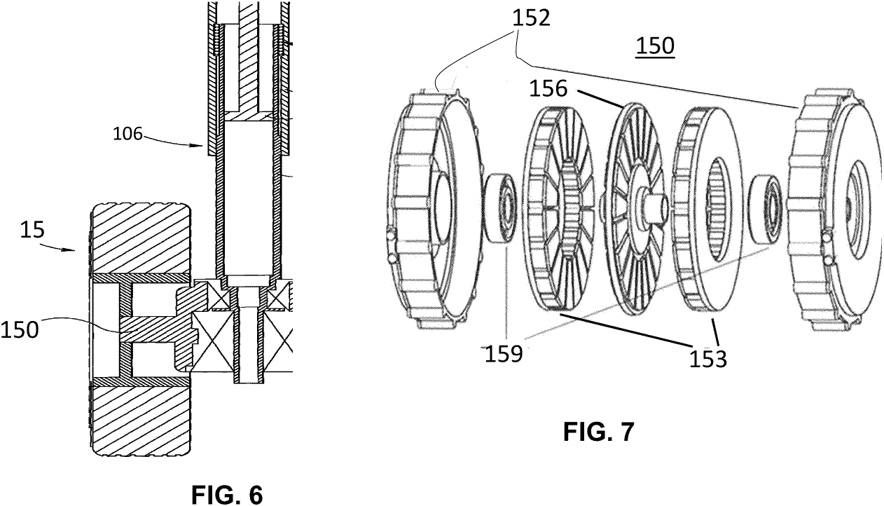

FIG. 6 depicts the wheel-based generator device 150 located in the tire (wheel) 15 and including the diversion of power up along or through the absorber housing shaft 106 via the power cabling and attached charge plug assembly shown in FIG. 2 according to an embodiment.

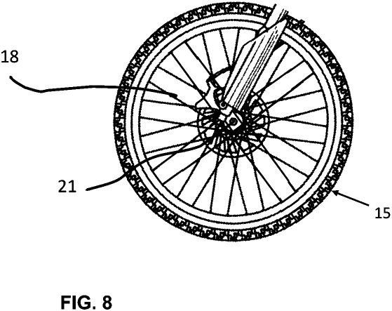

FIG. 7 depicts an exploded view of the wheel-based generator device 150 of FIG. 6 that is used as the wheel-type electric vehicle generator range extender and recharger. The wheel-based generator device 150 of FIG. 7 includes a pancake-shaped generator such as shown and described in applicant’s commonly owned U.S. Patent Application Serial No. 17/590,77 and incorporated by reference herein. The pancake shaped generator can be of a flex design. In such a design, the wheel-based generator attaches to the rim of the wheel and incorporates the stator and the rotor. The wheel-based generator has two designs: a first Device 1 is enclosed in a housing or casing. The stator is affixed to the casing wall while the rotor is allowed to spin freely with the rotation of the wheel. The rotor induces a current in the stator which is then directed to the charge controller to be used to recharge the battery or power the vehicle. A second Device 2 is a hubless generator design. In the hubless configuration the rotor and the stator are built into a housing that is affixed to the hub of the vehicle. As the wheel rotates the rotor spins with the tire rotation and induces a current in the stator. This power is diverted to the charge computer and then passed on to the battery bank or vehicle.

This wheel-based generator device 150 and an attached corresponding power cabling and charge plug assembly can be used as a level 2 charger that can interface with the standard J1772 or like charge port provided on the vehicle while the vehicle is moving. The wheel-based pancake-shaped generator device 150 of FIG. 7 includes outer housing enclosure elements 152 for housing a stator shown as elements 153 in the exploded view, a rotor 156 situated between the stator elements and bearings 159 for permitting rotor rotation relative to the stator. This pancake-shaped generator device 150 is configured to recharge an electric vehicle (e.g., a sedan) in 4-10 hours at the targeted speed of 30 m.p.h.. In this device, the rotor 156 provides a rotating magnetic field that drives the rotating armature; the rotor is connected to the wheel and takes advantage of the rotational energy of the tire; in this generator range extender charger device, the stator or coil 153, located in the wheel well/cover converts the rotating magnetic field of the rotor 156, e.g., located in the tire spokes, into an electric current which is used to recharge the battery 300 or connected batteries forming a battery bank (not shown) for powering the vehicle.

### Stators and Rotors

It is the case that many rotary electrical machines require current to be conveyed to (or extracted from) a moving rotor, usually by means of sliding contacts: a commutator or slip rings. These contacts are often the most complex and least reliable part of such a machine and may also limit the maximum current the machine can handle. For this reason, when machines must use two sets of windings, the windings carrying the least current are usually placed on the rotor and those with the highest current on the stator.

The field coils can be mounted on either the rotor or the stator, depending on whichever method is the most cost-effective for the device design.

For generators, the field current is smaller than the output current. Accordingly, the field is mounted on the rotor and supplied through slip rings. The output current is taken from the stator, avoiding the need for high-current sliprings. In DC generators, which are now generally obsolete in favor of AC generators with rectifiers, the need for commutation meant that brush gear and commutators could still be required. For the high-current, low-voltage generators used in electroplating, this could require particularly large and complex brush gear.

By increasing the number of pole faces surrounding the Gramm ring, the ring can be made to cut across more magnetic lines of force in one revolution than a basic two-pole generator. Consequently, a four-pole generator could output twice the voltage of a two-pole generator, a six- pole generator could output three times the voltage of a two-pole, and so forth. This allows output voltage to increase without also increasing the rotational rate.

In a multipolar generator, the armature and field magnets are surrounded by a circular frame or “ring yoke” to which the field magnets are attached. This has the advantages of strength, simplicity, symmetrical appearance, and minimum magnetic leakage, since the pole pieces have the least possible surface and the path of the magnetic flux is shorter than in a two -pole design.[1]

### Winding Materials

Coils are typically wound with enameled copper wire, sometimes termed magnet wire. The winding material must have a low resistance, to reduce the power consumed by the field coil, but more importantly to reduce the waste heat produced by ohmic heating. Excess heat in the windings is a common cause of failure. Owing to the increasing cost of copper, aluminum windings are increasingly used.

An even better material than copper, except for its high cost, would be silver as this has even lower resistivity. Silver has been used in rare cases. During World War II the Manhattan project to build the first atomic bomb used electromagnetic devices known as calutrons to enrich uranium. Thousands of tons of silver were borrowed from the U.S. Treasury reserves to build highly efficient low-resistance field coils for their magnets. Showing the magnetic lines inducing current. Electrical conductors moving through a steady magnetic field, or stationary conductors within a changing magnetic field, will have circular currents induced within them by induction, called eddy currents. Eddy currents flow in closed loops in planes perpendicular to the magnetic field.

In an embodiment, the portable retractable attachable/detachable wheel-based standalone generator of a range extender is of a high efficiency, brushless generator design that utilizes the wheel or wheel rim, together with the mechanical energy of the itself to create a brushless generator that will deliver power to the engine directly or can be diverted to the battery bank for recharging. This device can be configured several ways. The primary way to configure this device is denoted as Device 1. In the case of Device 1 the magnet, copper or enameled wire is wound tightly around an iron core and fashioned such that it is encompassed by the wheel cover/wheel well 36 shown in FIG. 1. The wheelcover is fixed for the rear tires and is movable for the front tires. This armature takes up a large percentage of the wheel well or cover. This assembly constitutes the stator body housing and hasElectrodes made of soft iron. This armature winding is completely concealed by the wheel cover/well and is in the shape of the wheel cover 36. A dense magnet wiring cluster forms the firstmajor segment of the Device 1 generator. There are several layers of wire in this cluster. The armature coil is stationary. The magnetic field is created through electric current in the wire- wound coil and strengthened by a soft-iron core. The armature coil assembly converts themechanical energy of the rotating tire 15 into electrical energy by passing the permanent magnet wheel spokes (not shown) through this armature winding. The wheel 15, which houses the permanent magnets onthe wheel spokes thus becomes the rotor. The Rotor produces rotating magnetic flux or rotating magnetic field associated with the rotor inducing electricity in the armature coil attachedto the wheel well or wheel cover 36. The electricity produced is then diverted to the charge controller via the power cabling and attached charge plug assembly 155. The charge controller now powers the engine directly or recharges the battery 300 based on the currentneeds of the vehicle. In an embodiment, shown in FIG. 8, permanent steel magnetic spokes 28 are arranged at intervals around a center wheel hub 21 of attached wheel 15. Each permanent magnet spoke 18 is attached in sequence to the center hub. Each magnetic spoke is adhered to the center hub alternating the north and south pole orientation of eachmagnet. They are arranged in a pattern of four or more spokes and adhered to the wheel to form a tire. The spokes 18 are designed such that in addition to being permanent magnets they transmit thepower from the hub to the rubber tube of the wheel. It performs two functions. To hold the entirebicycle/vehicle - the whole weight of the bicycle/vehicle, is concentrated on the hub. The spokeshold this hub and transfer the weight to rim of the wheel. The entirety of the spokes are covered by permanent magnets. The magnetic field directions generated by the permanent steel magnets are consistent and all face the inner side or the outer side of the rotor.

In a second device (referred to as Device 2), the electrodes and the permanent magnets are fixed in the wheel cover/well 36. The wheel-based range extender charger Device 2 operates in much the same way as Device 1, however, in Device 2 the wheel spokes are wound with copper wire to create the armature winding and thereby making this the rotor assembly. While the permanent magnets are place in the wheelwell or wheel cover 36. The wheel well permanent magnets are stationary in this device.

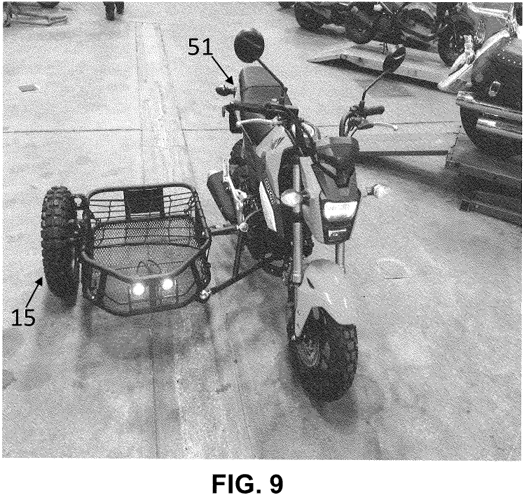

In an embodiment, the wheel power generator can be built into the wheel well of the electric vehicle, placed in a side car-based system mounted in the wheel 15 alongside the vehicle 51 as shown in FIG. 9, or towed behind the vehicle in a portable charging system which is essentially a mobile commercial generator that uses the same principle of converting the mechanical energy of the tire into electricity. The system utilizes a trailer mounted range extender that resides in standby mode until a low charge signal is received from the vehicle. While the vehicle is being driven, the tethered trailer activates the generator, which in turn recharges the EV battery or powers the vehicle directly. The idea is that this charge on the go system will negate the need for lengthy charging stops. By the wheel cover type generator of the range extender for the electric vehicle, the overall vehicle range can be effectively increased to rival and exceed that of gasoline powered vehicles.

In order to gain exponential range extension, provide more power for greater horsepower, create aplatform that will have immediate and long-term environmental benefits while simultaneously reducing charging times, improving EV overall efficiency, the present invention adopts following technical scheme:

The electric vehicle recharging system of the embodiments described herein greatly extends the range of any vehicle, and can be further characterized as including:
a wheel cover-based armature winding, wheel spoke based permanent magnets, tires, charge controller and battery bank., axle, magnetic conductive soft iron; a
A magnetic conductive soft iron and permanent magnet are spaced and are bonded to the wheel spokes, a magnetic conductive soft iron and a set of permanent magnets pole in a pair;
A permanent magnet has multi-spoke and in circular arc, the magnetic direction that all permanent magnets produce is consistent; In Device 2 the Armature winding is in a circular arc.
Quantity, the shape and size of described magnetic conductive soft iron are consistent with permanent magnet and size of the wheel; or in Device 2 the size of the wheel well/cover;
The wheel cover casing is fixed on rear vehicle body panels, wheel cover casing is movable on front body panels and stator core is fixed on wheel well/cover, rotor is fixed on spokes of the rim, and as wheel rotates around the axle the rotor can rotate around stator core wheel cover casing therebyinducing electricity.

The electric vehicle recharging system that greatly extends the range of any vehicle, said wheel-based range extender device, Grayson Range Extender (GRE), as above, is characterized in that:

The permanent magnet and magnetic conductive soft iron can be mounted on the wheel cover/wellor the wheel spokes, this then becomes the stator assembly;

A rotor phase winding can be wrapped around the spokes of the wheel or wrapped around an armature and placed in the wheel cover;

Because this is a frictionless system the power produced is scalable to the desired recharge time and range;

Beneficial effect of the present invention include, but are not limited to:
(1) system increases the range of an electric vehicle up to 400%;
(2) compared with traditional range extenders this device requires no additional fuels;
(3) compared with traditional tire-based generators this device has much greater charging capacity and reliability;
(4) compared with other types of wheel based recharging systems like regenerative breaking and bike generators, this system has lower coefficient of friction, generates a negligible amount of heatand is infinitely more reliable;
(5) can be very applicable and installed on all existing electric vehicles;
(6) compared to other range extenders this device lowers the sprung weight of the vehicle;
(7) compared to other range extenders this device has zero emissions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. An electric vehicle generator range extending charging system comprising;
a wheel assembly including a wheel having a plurality of wheel spokes, the wheel assembly configured for attachment/detachment to a location of a vehicle, the wheel assembly having a wheel cover situated in proximity to the wheel:
a rotating wheel-based rotor comprising of permanent magnets which are affixed to the wheel by adhering them to the spokes of the wheel; and a coiled copper, magnet or enameled wire tightly wound around a sufficiently large armature which is housed in the wheel well/cover and providing a coil field, said wheel passes through the wheel well and thus passes through the armature and coil field;
wherein while the vehicle is moving, the rotational energy of the wheels of the moving vehicle powers the generator such that as the permanent magnets pass through the coil field of the copper wire electricity is produced to power the vehicle or recharge a battery bank; and
a charge controller for directing the flow of the electricity either to the vehicle or a battery bank.

2. The charging system of claim 1, wherein the wheel assembly comprises:
a shock absorber system, the wheel being mounted on the shock absorber system to allow the wheel to be in maximum contact with a road surface while a vehicle is moving.

3. The charging system of claim 1, wherein the wheel assembly comprises:
a pancake-shaped generator housed in the wheel assembly.

4. An electric vehicle generator range extending charging system comprising:
a rotating wheel-based rotor comprises a tightly wound wire usually around each wheel spoke, the wheel spokes being affixed to wheels of the vehicle, and
a permanent magnet armature which is housed in the wheel well/cover and providing a coil field, the wheel passing through the wheel well and passing through the armature and coil field;
wherein while the vehicle is moving, the permanent magnets pass through the coil field of the armature to produce electricity to power the vehicle or recharge a battery bank; and
a charge controller for directing a flow of electricity either to the vehicle or the battery bank.
